(19) United States
(12) Patent Application Publication
(10) Pub. No.: US 2026/0148963 A1
(43) Pub. Date: May 28, 2026

(54) THREE-DIMENSIONAL HIERARCHICAL ANODE STRUCTURE, MANUFACTURING METHOD THEREFOR, AND LITHIUM SECONDARY BATTERY COMPRISING SAME

(71) Applicant: POSTECH Research and Business Development Foundation, Pohang-si (KR)

(72) Inventors: Sang-Min LEE, Pohang-si (KR); Sumin KO, Pohang-si (KR); Kyungjun KIM, Pohang-si (KR); Sugang LEE, Pohang-si (KR)

(73) Assignee: POSTECH Research and Business Development Foundation, Pohang-si (KR)

(21) Appl. No.: 19/399,930

(22) Filed: Nov. 25, 2025

(30) Foreign Application Priority Data
Nov. 27, 2024 (KR) 10-2024-0171919
Oct. 29, 2025 (KR) 10-2025-0159611

(51) Int. Cl. H01M 4/133; H01M 4/02; H01M 4/36; H01M 4/58; H01M 4/587; H01M 4/62; H01M 10/0525

(52) U.S. Cl. CPC H01M 4/133; H01M 4/366; H01M 4/5825; H01M 4/587; H01M 4/62; H01M 10/0525; H01M 2004/021; H01M 2004/027

(57) ABSTRACT

Disclosed are an anode structure for a lithium secondary battery and a method for manufacturing the same, the anode structure including: a first active material layer of a carbon-based material powder including a first coating film having a negative charge on the surface in an electrolyte; and a second active material layer of a carbon-based material powder laminated on the first active material layer and including a second coating film having a positive charge on the surface in an electrolyte.

### CROSS-REFERENCE TO RELATED APPLICATION(S)

This application is based on and claims priority under 35 U.S.C. 119 to Korean Patent Application No. 10-2024-0171919, filed on Nov. 27, 2024, and Korean Patent Application No. 10-2025-0159611, filed on Oct. 29, 2025, in the Korean Intellectual Property Office, the disclosure of which is herein incorporated by reference in its entirety.

### BACKGROUND OF THE INVENTION

### 1. Field of the Invention

The present disclosure relates to a three-dimensional anode structure for a lithium secondary battery and a manufacturing method therefor and, more specifically, to a three-dimensional anode structure having a hierarchical structure in the height direction of an anode and a manufacturing method therefor.

### 2. Description of the Prior Art

With the spread of supply of portable small electric and electronic devices, new secondary batteries, such as nickel-hydrogen batteries and lithium secondary batteries, have been being actively developed.

In recent years, three-dimensional structures have been introduced to secure anode spaces capable of storing lithium. Such structures can lower the effective current density and provide spaces capable of accommodating volume changes resulting from adsorption and desorption of lithium. Representatively, three-dimensional electronically conductive network structures, such as three-dimensional copper nanowires, carbon paper, and CNTs, have been studied.

However, conventional three-dimensional anode structures have problems in that, due to top-plating in which lithium is deposited preferentially from the top portion of the structure during lithium deposition, lithium is deposited only on the top portion of the structure, thereby hindering the effective utilization of the entire space of the bottom portion for lithium storage, and moreover, this top-plating of lithium induces the dendritic growth of lithium, thereby providing a large surface area, causing severe reactions with electrolytes, resulting in electrolyte depletion and poor lithium deposition/stripping efficiency.

To solve these problems, studies have been conducted on hierarchical structures using lithiophilic metal materials.

For example, Korean Patent Publication No. 2023-0056938 discloses a three-dimensional structured electrode structure having a Cu framework and containing a nitrate including a lithiophilic metal inside.

Additionally, Korean Patent No. 10-2690898 discloses a three-dimensional hierarchical electrode structure. The bottom portion of the electrode has large pores and contains a lithiophilic metal, but the top portion of the electrode has small pores and contains no lithiophilic metal.

However, despite such structures, there is still a need for a three-dimensional anode structure that is stable over long-term cycling and operates under high-rate conditions.

### PRIOR ART DOCUMENTS

### Patent Documents

(1) Korean Patent Publication No. 2023-0056938

(2) Korean Patent No. 10-2690898

### BRIEF DESCRIPTION OF THE DRAWINGS

Accordingly, an aspect of the present disclosure is to provide a novel three-dimensional hierarchical anode structure.

Another aspect of the present disclosure is to provide a three-dimensional hierarchical anode structure having an efficient structure for suppressing top plating.

Still another aspect of the present disclosure is to provide a three-dimensional anode structure that is stable during long-term cycling and operates under high-rate conditions.

Still another aspect of the present disclosure is to provide a method for manufacturing a three-dimensional anode structure.

Still another aspect of the present disclosure is to provide a lithium secondary battery including the above-described anode structure.

In an aspect of the present disclosure, there is provided an anode structure for a lithium secondary battery, including: a first active material layer of a carbon-based material powder including a first coating film having a negative charge on the surface in an electrolyte; and a second active material layer of a carbon-based material powder laminated on the first active material layer and including a second coating film having a positive charge on the surface in an electrolyte.

The first and second coating films may be siloxane coating films.

Each of the carbon-based materials may include at least one selected from the group consisting of artificial graphite, natural graphite, graphitized carbon fibers, graphitized mesocarbon microbeads, petroleum coke, carbonized resin, carbon fibers, and pyrolytic carbon.

The first active material layer may have a thickness of 30 to 50 μm, and the second active material layer may have a thickness of 30 to 50 μm.

The first coating film may contain, as a functional group, at least one selected from the group consisting of —PO₃H₂, —COOH, —SO₄H, —SO₃H, —OH, and —BO₃.

The first coating film may contain, as a function group, at least one selected from the group consisting of —NH2, —NH—, imidazolium, and —N+(CH)³)₃.

The first coating film may be a PTFE coating film. In such a case, the second coating film may be a siloxane coating film.

In accordance with another aspect of the present disclosure, there is provided a lithium secondary battery, including: an anode comprising the above-described anode structure; a cathode containing an active material represented by the chemical formula LiₓNi_{1-y}M′_{y}O_{2-α}A_{α} (where, 0.95≤x≤1.1, 0≤y≤0.5, 0≤z≤0.5, 0≤α≤2, M′ is at least one element selected from the group consisting of Al, Ni, Co, Mn, Cr, Fe, Mg, Sr, V, and a rare earth element, and A is an element selected from the group consisting of F, S, and P); a separator for separating the anode and the cathode; and an electrolyte containing an organic-based polar solvent.

In accordance with still another aspect of the present disclosure, there is provided a method for preparing an anode active material for a lithium secondary battery, the method including: preparing a carbon-based material; and forming a siloxane coating film having a positive surface charge on the surface of the carbon-based material.

The forming of the siloxane coating film may include: dissolving a silane in anhydrous ethanol to prepare a silane solution; mixing a carbon-based material powder with the silane solution, followed by heating and stirring; and filtering and drying the reaction product.

The silane may include (3-aminopropyl)triethoxysilane.

The heating step may be performed at 50 to 70° C.

According to an aspect of the present disclosure, top plating of lithium can be suppressed by providing a hierarchic charge structure having different types of surface charges in the top and bottom portions of an anode structure.

According another aspect of the present disclosure, a three-dimensional hierarchical structure can be provided by forming different surface functional groups inside an anode structure through simple wet coating.

According to still another aspect of the present disclosure, the anode structure of the present disclosure can suppress delithiation or degradation during repeated charge and discharge.

### DETAILED DESCRIPTION OF THE EXEMPLARY EMBODIMENTS

The above and other aspects, features and advantages of the present disclosure will be more apparent from the following detailed description taken in conjunction with the accompanying drawings.

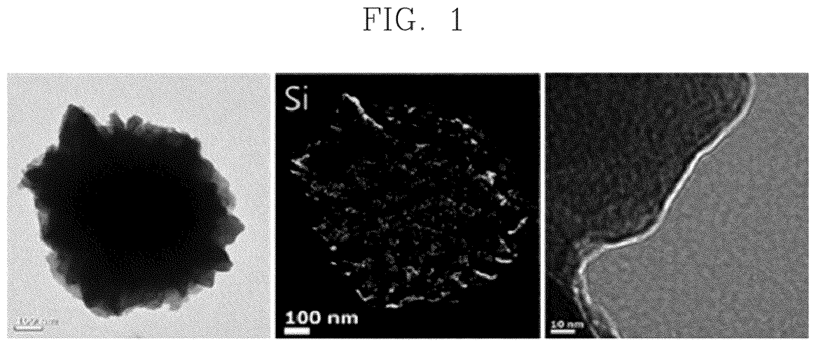

FIG. 1 shows TEM images of an active material composition according to one example of the present disclosure.

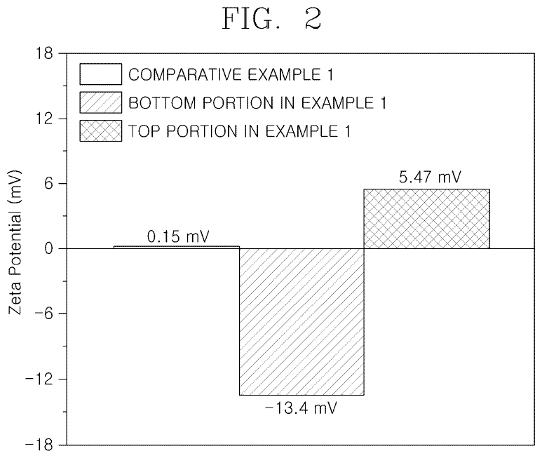

FIG. 2 shows a graph illustrating the Zeta potential measurement results of top and bottom portions of an anode structure according to one example of the present disclosure.

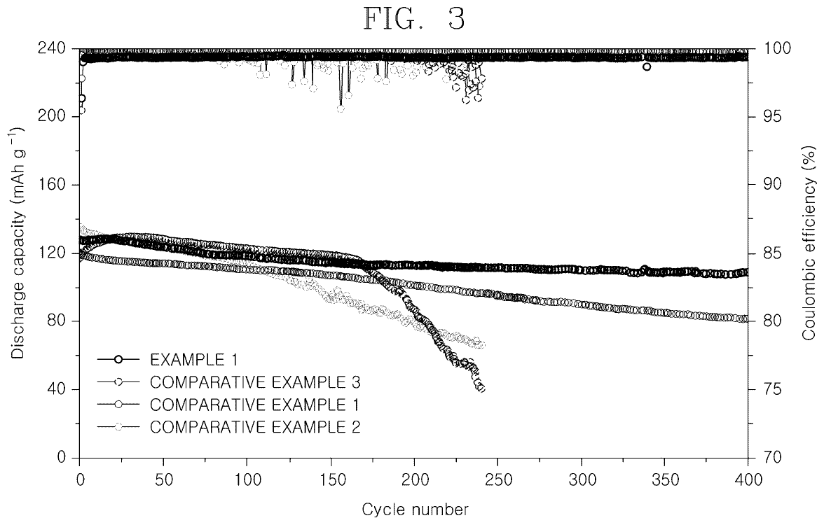

FIG. 3 shows a graph illustrating the cycle test results of a coin-cell fabricated according to one example of the present disclosure.

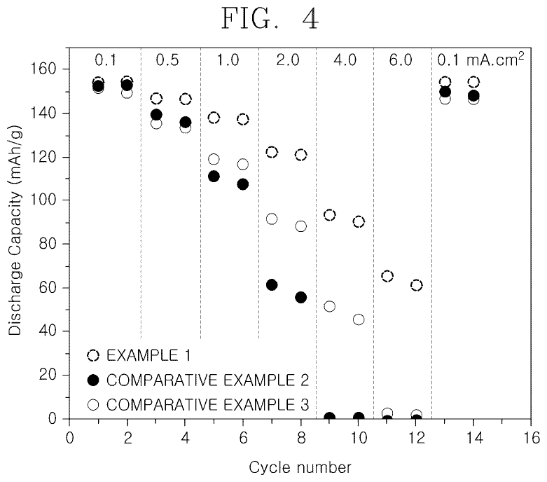

FIG. 4 shows a graph illustrating the rate capability measurement results of a coin cell fabricated according to one example of the present disclosure.

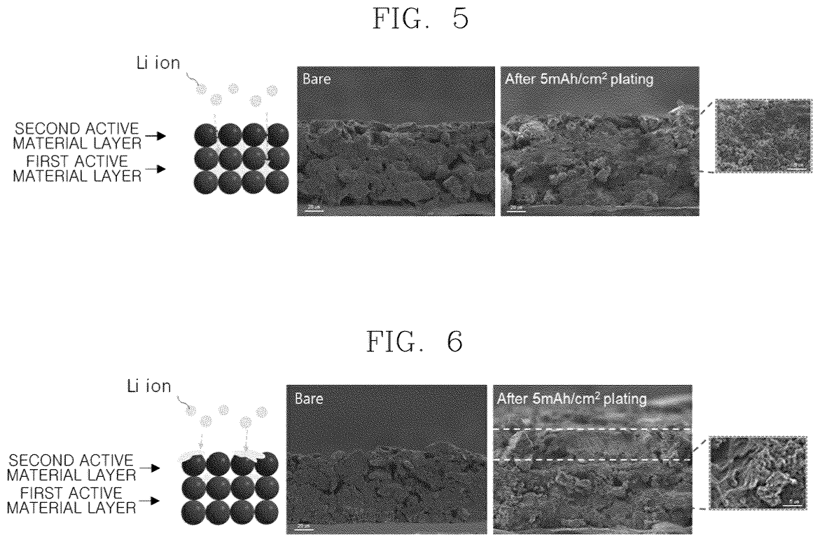

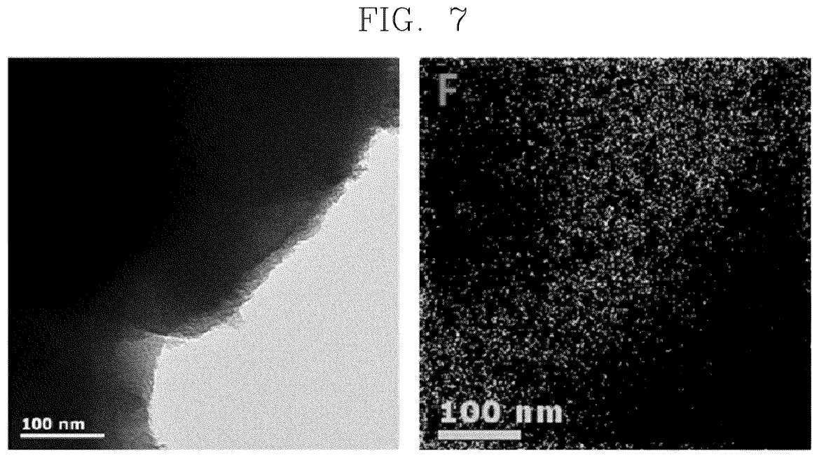

FIGS. 5 and 6 show electron microscope images obtained by observing the deposition states of lithium on active material layers after the operation of coin cells of an example and a comparative example, respectively.

FIG. 7 shows TEM images of an active material composition prepared in Experimental Example 3.

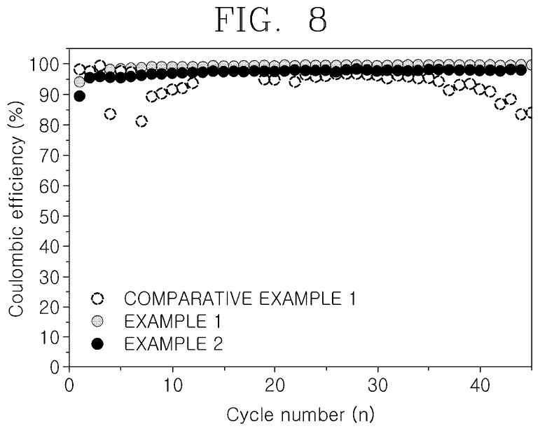

FIG. 8 illustrates Coulombic efficiency test results of examples and a comparative example.

### DETAILED DESCRIPTION OF THE EXEMPLARY EMBODIMENTS

It is to be noted that in the following description, only the parts necessary for understanding exemplary embodiments of the present disclosure will be described, and descriptions of the other parts will be omitted so as not to deviate from the gist of the present disclosure.

The terms and words used in this description and the appended claims are not to be interpreted in common or lexical meaning but, based on the principle that an inventor can adequately define the meanings of terms to best describe the disclosure, to be interpreted in the meaning and concept conforming to the technical concept of the present disclosure. The features described in exemplary embodiments and drawings shown herein are for merely illustrating one of the most preferable exemplary embodiments but are not intended to represent the technical idea of the present disclosure, and thus the present disclosure may cover various equivalents and modifications which can substitute for the exemplary embodiments at the time of filing the present application.

Hereinafter, exemplary embodiments of the present disclosure will be described in more detail with reference to the accompanying drawings.

In the present disclosure, a three-dimensional anode structure includes an anode current collector and an anode active material laminated on the anode current collector to form a three-dimensional framework. The anode active material includes a carbon-based material powder and a siloxane coating film formed on the surface of the powder particles.

Hereinafter, an anode active material and a three-dimensional anode structure including the same are described in detail.

### A. Preparation of Anode Active Material

### A-1. Preparation of Anode Active Material Having Siloxane Coating Film

In the present disclosure, the carbon-based material powder includes a siloxane coating film formed on the particle surface. The siloxane coating film may cover at least a portion or the entirety of the particle surface of the carbon-based material.

In the present disclosure, the carbon-based material may be at least one selected from the materials composed of crystalline or amorphous carbon materials, such as graphite, for example, artificial graphite or natural graphite, graphitized carbon fibers, and graphitized mesocarbon microbeads, petroleum coke, carbonized resin, carbon fibers, and pyrolytic carbon. In the present disclosure, the carbon-based material preferably has a particle size of 20μm or less. In the present disclosure, examples of the carbon-based material may include low-crystalline carbon and high-crystalline carbon. Examples of the low-crystalline carbon may include soft carbon and hard carbon, and examples of the high-crystalline carbon may include high-temperature carbonized carbon, such as natural or artificial graphite in an amorphous, flake, plate-like, spherical, or fibrous form, Kish graphite, pyrolytic carbon, mesophase pitch-based carbon fiber, meso-carbon microbeads, mesophase pitches, and petroleum or coal tar pitch derived cokes.

In the present disclosure, a siloxane coating film on the peripheral region of the carbon-based material powder may be formed by a sol-gel method. The coating procedure by the sol-gel method is described hereinafter.

In the present disclosure, a silane for forming the siloxane coating film may be at least one selected from the group consisting of (3-aminopropyl)triethoxysilane, tetramethyl orthosilicate, tetraethyl orthosilicate, and hydroxypropyl trimethoxysilane.

In the present disclosure, the siloxane coating film includes a terminal functional group charged in an electrolyte.

In the present disclosure, the siloxane coating film may contain, as a functional group negatively charged in an electrolyte, at least one selected from the group consisting of hydroxyl (—OH), phosphonate (—PO₃H₂), carboxyl (—COOH), sulfate (—SO₄H), sulfonate (—SO₃H), and borate (—BO₃). In the present disclosure, the siloxane coating film may contain, as a functional group positively charged in an electrolyte, at least one selected from the group consisting of —NH2, secondary amine (—NH—), imidazolium, and quaternary ammonium (—N⁺(CH₃)₃).

Hereinafter, Carbon-based Materials Having siloxane coating films of —OH and —NH2 functional groups, respectively, are described.

A silane aqueous solution is prepared to apply a silane coating film having a functional group onto the surface of carbon-based material powder particles.

In the present disclosure, various sources may be used as silane. For example, at least one selected from the group consisting of 3-aminopropyltriethoxysilane (APTES), tetramethyl orthosilicate (TMOS), tetraethoxysilane (SiC₈H₂₀O₄, TEOS), tetrapropyl orthosilicate (TPOS), tetra isopropyl orthosilicate (TiPOS), tetrabutyl orthosilicate-(TBOS), hydroxypropyl trimethoxysilane, and tetramethyl orthosilicate (TMOS) may be used.

First, in an embodiment, a process for preparing a siloxane coating film having an-OH functional group on the surface of a carbon-based material is described as below. Tetramethyl orthosilicate (TMOS) is mixed with deionized water and an appropriate concentration of HCl (e.g., 2 M HCl). The added acid serves as a catalyst that promotes hydrolysis, and thus increases the hydrolysis rate, induces the hydrolysis reaction to be completed throughout the solution, and promotes the reaction at room temperature. Then, the prepared siloxane aqueous solution is mixed with a carbon-based material powder. The mixing may be conducted in, for example, a planetary mixer. The pH of the aqueous solution is preferably 3 to 4. At a pH of 2 or lower, gelation occurs at a temperature of 50° C. or higher. The mixed aqueous solution is subjected to hydrolysis and condensation at a temperature of 20 to 30° C. for 5 to 20 hours, and then the aqueous solution that has completed the reaction is filtered and vacuum-dried at room temperature or at 20 to 30° C.

A siloxane coating film having an —NH2 functional group as a positively charged functional group may be formed as follows. A mixed solution of 3-aminopropyltriethoxysilane and anhydrous ethanol is prepared. Particularly, the weight ratio of silane and anhydrous ethanol may be 1:10-1:30. A carbon-based material is added thereto so that the weight ratio of the carbon-based material to silane is 0.5-2, and the mixture is stirred in a hot stirrer while the temperature is maintained at 60° C. After the reaction for 5 to 20 hours, the aqueous solution is filtered and vacuum-dried at room temperature or at a temperature of 20 to 30° C.

A thick siloxane coating film may hinder the migration of lithium ions into the carbon-based material since the ion conductivity is inversely proportional to the layer thickness. In contrast, a thin siloxane coating layer resulting from an excessively shortened reaction time may not be uniformly coated on the entire surface of the carbon-based material. In the present disclosure, the thickness of the siloxane coating film may be 100 nm or less, 50 nm or less, 40 nm or less, 30 nm or less, 25 nm or less, or 20 nm or less. Alternatively, the thickness of the siloxane coating film may be 1 nm or more, 5 nm or more, or 10 nm or more. Preferably, the thickness of the siloxane coating film is 1 to 10 nm.

### A-2. Preparation of Anode Active Material Having Polytetrafluoroethylene (PTEE) Coating Film

In another embodiment of the present disclosure, a carbon-based material powder includes a polytetrafluoroethylene (PTFE) coating film formed on the particle surface. The PTFE coating film may cover at least a portion or the entirety of the surface of the carbon-based material particles. In another embodiment of the present disclosure, the carbon-based material may be graphite, such as artificial graphite or natural graphite, low-crystalline carbon, or the like, as described above. The description of the carbon-based material overlapping with the above is omitted.

The PTFE coating film has a negative zeta potential. Therefore, an anode active material having the PTFE coating film may be negatively charged. A process for preparing an anode active material having the PTFE coating film is described as below.

First, an aqueous PTFE emulsion is prepared. The emulsion is mixed with a carbon-based material powder. Then, the mixture of the aqueous PTFE emulsion and the carbon-based material powder is added to deionized water, followed by uniform dispersion at room temperature through magnetic stirring. The dispersed mixture is heated to remove the solvent, and dried in an oven in ambient air.

As described above, the ion conductivity is inversely proportional to the layer thickness, and thus a thick PTFE coating film may hinder the migration of lithium ions into the carbon-based material. In contrast, a thin PTFE coating layer resulting from an excessively shortened reaction time may not be uniformly coated on the entire surface of the carbon-based material. In the present disclosure, the thickness of the PTFE coating film may be 100 nm or less, 50 nm or less, 40 nm or less, 30 nm or less, 25 nm or less, or 20 nm or less. Alternatively, the thickness of the PTFE coating film may be 1 nm or more, 5 nm or more, or 10 nm or more. Preferably, the thickness of the PTFE coating film is 1 to 10 nm.

### B. Manufacture of Three-Dimensional Hierarchical Anode Structure

### B-1. Utilization of Anode Active Material Having Siloxane Coating Film

In the three-dimensional anode structure of the present disclosure, the charge of the terminal functional group of the siloxane coating film may be hierarchized along the thickness direction.

Specifically, the present disclosure has a layer structure including: a first active material layer including a terminal functional group having a negative charge; and a second active material layer, on the first active material layer, including a siloxane coating film providing a terminal group having a positive charge. The layer structure of the three-dimensional anode structure may be variously embodied. For example, the layer structure may include an additional layer between the first active material layer and the second active material layer or an additional layer laminated beneath the first active material layer or on the second active material layer. These additional layers may be designed to have a different functional group or a different charge amount from the first active material layer or the second active material layer.

As described above, the three-dimensional structure includes a first active material layer having a negative surface charge and a second active material layer having a positive surface charge on the first active material layer. The first active material layer is located closer to the anode current collector than the second active material layer. Such an arrangement enables positively charged lithium ions to be preferentially filled in the first active material layer closer to the anode current collector due to the attraction with the first active material layer and the repulsion with the second active material layer. In the three-dimensional structure of the present disclosure, top plating of lithium ions can be suppressed.

The above description illustrates the mechanism by which the surface functional group helps the filling of lithium ions at the anode in the three-dimensional anode structure of the present disclosure, but this description is provided merely for a better understanding of the present disclosure and does not preclude the operation of mechanisms other than the one described.

In the present disclosure, the three-dimensional hierarchical anode structure including the first active material layer and the second active material layer may be manufactured by the following method.

First, the first active material layer may be formed by preparing a slurry composition and then applying the slurry composition onto an anode current collector, wherein the slurry composition is prepared by mixing an active material of a carbon-based material including a siloxane coating film having a negatively charged functional group, such as-OH, with a binder and a conductive material at a predetermined ratio.

A second active material layer is laminated on the first active material layer. The second active material layer may be formed by preparing a slurry composition and then applying the slurry composition onto the first active material layer, wherein the slurry composition is prepared by mixing an active material of a carbon-based material having a positively charged functional group, such as —NH2, with a binder and a conductive material at a predetermined ratio.

In the hierarchical structure of the present disclosure, the first active material layer preferably accounts for 40 to 60% of the thickness of the hierarchical structure. Illustratively, the thickness of the first active material layer is preferably 30 to 50 μm. In the present disclosure, the thickness of the second active material layer is preferably 40 to 60% of the thickness of the hierarchical structure in an electrolyte.

Illustratively, each of the first active material layer and the second active material layer may have a thickness of 30 to 50 μm.

A specific forming method for each active material layer is as follows.

In each of the active material layers of the present disclosure, an anode active material may be contained in a content of 80 wt% or more, 85 wt% or more, or 90 wt% or more relative to the total weight of each active material layer. The anode active material may be contained in a content of 99 wt% or less, 98.5% or less, 98% or less, 97.5% or less, 97% or less, 96.5% or less, or 96% or less, relative to the total weight of each active material layer.

Examples of the conductive material may include: graphite, such as natural graphite or artificial graphite; carbon-based materials, such as carbon black, acetylene black, Ketjen black, channel black, furnace black, lamp black, thermal black, and carbon fibers; powders or fibers of metals, such as copper, nickel, aluminum, and silver; and conductive polymers, such as polyphenylene derivatives, and these may be used alone or in a mixture of two or more of the foregoing. The conductive material may be contained in a content of 0.1 to 20 wt%, 0.1 to 15 wt%, or 0.1 to 10 wt% relative to the total weight of each anode active material layer.

Examples of the binder may include polyvinylidene fluoride (PVDF), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated-EPDM, styrene-butadiene rubber, nitrile-butadiene rubber, fluoro-rubber, and various copolymers thereof. The binder may be contained in a content of 0.1 to 15 wt%, 0.1 to 10 wt%, or 0.1 to 5 wt% relative to the total weight of each anode active material layer.

The solvent may be any solvent that is generally used in the art, and examples thereof may include dimethyl sulfoxide (DMSO), isopropyl alcohol, N-methylpyrrolidone (NMP), acetone, and water, and these may be used alone or in a mixture of two or more of the foregoing. The amount of solvent used is sufficient to dissolve or disperse the active material, the conductive material, and the binder considering the thickness of slurry applied and the manufacturing yield, and to provide a viscosity capable of exhibiting excellent thickness uniformity during application.

### B-2. Utilization of Anode Active Material Having PTFE Coating Film

In the three-dimensional anode structure described above, the first active material layer may be embodied using an anode active material having a PTFE coating film. In such a case, as described above, the second active material layer may be embodied using “a second active material including a siloxane coating film providing a positively charged terminal group”.

In the description of the three-dimensional structure using an anode active material having the PTFE coating film, the description overlapping with that described in “B-1. Utilization of anode active material having siloxane coating film” is omitted.

A method for implementing a first active material layer using an anode active material having a PTFE coating film is described as below.

The anode active material having a PTFE coating film in 10 mL of deionized water is subjected to ultrasonic treatment at room temperature, thereby obtaining a uniform dispersion. This dispersion is slurry casted on an anode current collector using a bar coater. Thereafter, the resultant structure is dried in ambient air to stabilize the coating shape and remove the solvent. The dried anode current collector is vacuum dried to additionally remove the residual solvent. Through this process, the first active material layer may be formed on the anode current collector using the anode active material having a PTFE coating film.

The first active material layer is formed as such, and then a second active material layer is laminated on the first active material layer as described above. Since a specific method for forming the second active material layer is the same as described above, the description thereof is omitted.

As described above, in the hierarchical structure of the present disclosure, the first active material layer preferably accounts for 40 to 60% of the thickness of the hierarchical structure. Illustratively, the thickness of the first active material layer is preferably 30 to 50 μm.

In the present disclosure, the thickness of the second active material layer is preferably 40 to 60% of the thickness of the hierarchical structure in an electrolyte.

Illustratively, each of the first active material layer and the second active material layer may have a thickness of 30 to 50 μm.

### C. Lithium Secondary Battery

In the present disclosure, a lithium secondary battery may include an anode including the above-described three-dimensional anode structure, a cathode disposed to face the anode, and a separator and an electrolyte interposed between the anode and the cathode. Particularly, the lithium secondary battery may optionally further include: a battery case accommodating an electrode assembly including the anode, the cathode, and the separator; and a sealing member sealing the battery case.

In the present disclosure, the cathode may include a cathode current collector and a cathode active material layer formed on the cathode current collector.

The cathode current collector is not particularly limited as long as the anode current collector has conductivity without causing chemical changes in the battery and, for example, aluminum, stainless steel, nickel, titanium, carbonized carbon, or those obtained by treating the surface of aluminum or stainless steel with carbon, nickel, titanium, silver, or the like may be used. The cathode current collector may typically have a thickness of 3 to 500 μm, and fine irregularities may be formed on the surface of the current collector to enhance the adhesive strength of the cathode active material.

The cathode active material layer may be formed by applying a cathode slurry composition onto the cathode current collector, wherein the cathode slurry composition contains a conductive material and optionally a binder, together with the cathode active material.

In the present disclosure, the cathode active material may be a compound represented by the following chemical formula below.

### Chemical Formula 1

LiₓNi_{1-y}M′_{y}O_{2-α}A_{α} (where, 0.95≤x≤1.1, 0≤y≤0.5, 0≤z≤0.5, 0≤α≤2, M′ is at least one element selected from the group consisting of Al, Ni, Co, Mn, Cr, Fe, Mg, Sr, V, and rare earth elements, and A is an element selected from the group consisting of F, S, and P).

Illustratively, the cathode active material powder of the present disclosure may be a lithium-containing cobalt-based compound, a lithium-containing nickel-based compound, or a lithium-containing manganese-based compound. The term lithium-containing cobalt-based compound herein may encompass compounds composed of binary cations, ternary cations additionally containing a metal component, such as Ni or Mn, or higher multi-nary cations.

Illustratively, the composition of core particles may be a layered structure of LiₓNi_{y}Co_{1-z}Mn_{1-y-z}O₂ (0.95≤x≤1.1) containing quaternary cations. A layered structure of NCM has the advantages of having high capacity and high thermal stability. In the present disclosure, the compound may be a high-content nickel-based compound with y≥0.8. In the present disclosure, the compound may be a high-content nickel-based compound with y≥0.85, y≥0.90, or y≥0.95.

Particularly, the cathode active material may be contained in a content of 80 wt% or more, 85 wt% or more, or 90 wt% or more relative to the total weight of the cathode active material layer. Additionally, the cathode active material may be contained in a content of 99 wt% or less, 98.5% or less, 98% or less, 97.5% or less, 97% or less, 96.5% or less, or 96% or less. The cathode active material, when contained within the above content ranges, can exhibit excellent capacity characteristics, but is not necessarily limited thereto.

The conductive material is used to impart conductivity to an electrode, and examples of the conductive material may include: graphite, such as natural graphite or artificial graphite; carbon-based materials, such as carbon black, acetylene black, Ketjen black, channel black, furnace black, lamp black, thermal black, and carbon fibers; powders or fibers of metals,

such as copper, nickel, aluminum, and silver; and conductive polymers, such as polyphenylene derivatives, and these may be used alone or in a mixture of two or more of the foregoing. The conductive material may be contained in a content of 0.1 to 20 wt%, 0.1 to 15 wt%, or 0.1 to 10 wt% relative to the total weight of the cathode active material layer.

The binder serves to enhance the sticking between cathode active material particles and the adhesive strength between the cathode active material and the current collector. Examples of the binder may include polyvinylidene fluoride (PVDF), polyvinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, tetrafluoroethylene, polyethylene, polypropylene, an ethylene-propylene-diene monomer (EPDM), a sulfonated EPDM, a styrene-butadiene rubber (SBR), a fluorine rubber, or various copolymers of the foregoing, and these may be used alone and in a mixture of two or more of the foregoing. The binder may be contained in a content of 0.1 to 15 wt%, 0.1 to 10 wt%, or 0.1 to 5 wt% relative to the total weight of the cathode active material layer.

The cathode may be manufactured according to a conventional cathode manufacturing method except that the above-described cathode active material is used. Specifically, the cathode may be prepared by applying a cathode slurry composition, which is prepared by dissolving or dispersing the above-described cathode active material and, optionally, a binder and a conductive agent in a solvent, onto a cathode current collector, followed by drying and rolling.

The solvent may be a solvent that is generally used in the art, and examples thereof may include dimethyl sulfoxide (DMSO), isopropyl alcohol, N-methylpyrrolidone (NMP), acetone, and water, and these may be used alone or in a mixture of two or more of the foregoing. The amount of solvent used is sufficient to dissolve or disperse the cathode active material, the conductive material, and the binder considering the thickness of slurry applied and the manufacturing yield, and to provide a viscosity capable of exhibiting excellent thickness uniformity during application for cathode manufacturing.

In another embodiment, the cathode may be manufactured by laminating a film on the cathode current collector, the film being obtained by casting the cathode slurry composition on a separate support, followed by exfoliation from the support.

In the lithium secondary battery of the present disclosure, the anode may include an anode current collector and a three-dimensional hierarchical structure laminated on the anode current collector.

The anode current collector is not particularly limited as long as the anode current collector has conductivity without causing chemical changes in the battery and, for example, copper, stainless steel, aluminum, nickel, titanium, carbonized carbon, those obtained by treating the surface of copper or stainless steel with carbon, nickel, titanium, silver, or the like, or an aluminum-cadmium alloy may be used. The anode current collector may typically have a thickness of 3 μm to 500 μm, and similar to the cathode current collector, fine irregularities may be formed on the surface of the current collector to enhance the adhesive strength of the anode active material.

Since the three-dimensional hierarchical structure of the present disclosure is as described above, the description thereof is omitted.

In the lithium secondary battery of the present disclosure, the separator serves to separate the anode and the cathode and provide a passage for the migration of lithium ions. Any material that is commonly used as a separator for a lithium secondary battery may be used without limitation, and particularly, a material that has a low resistance to the migration of electrolyte ions and is well impregnated in an electrolyte is preferable. Specifically, a porous polymer film, for example, a porous polymer film formed of a polyolefin-based polymer, such as an ethylene homopolymer, a propylene homopolymer, an ethylene/butene copolymer, an ethylene/hexene copolymer, or an ethylene/methacrylate copolymer; or a laminated structure of two or more layers formed of these polymers may be used. Alternatively, a typical porous non-woven fabric, for example, a non-woven fabric composed of high-melting-point glass fiber, polyethylene terephthalate fiber, or the like may be used. Additionally, for ensuring heat resistance or mechanical strength, a coated separator containing a ceramic component or polymeric material may be used, and may optionally be used as a single-layer structure or a multi-layer structure.

In the present disclosure, the electrolyte may contain an organic solvent and a lithium salt.

The organic solvent is not particularly limited as long as it is a polar organic solvent that can serve as a medium through which ions involved in electrochemical reactions of the battery can migrate, and that allows the terminal functional group on the surface of the active material to retain its charge. For example, at least one selected from ether-based solvents including dibutyl ether or tetrahydrofuran, or carbonate-based solvents including dimethylcarbonate (DMC), diethylcarbonate (DEC), methylethylcarbonate (MEC), ethylmethylcarbonate (EMC), ethylene carbonate (EC), and propylene carbonate (PC) may be used. Illustratively, a carbonate-based solvent may be used as the solvent, and a mixture of a cyclic carbonate having high ionic conductivity and a high dielectric constant capable of enhancing the battery charge and discharge performance (e.g., ethylene carbonate or propylene carbonate) and a low-viscosity linear carbonate compound (e.g., ethylmethylcarbonate, dimethylcarbonate, or diethylcarbonate) is more preferable.

The lithium salt may be used without particular limitation as long as it is a compound capable of providing lithium ions for use in a lithium secondary battery. Specific examples of the lithium salt may include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, LiB(C₂O₄)₂, or the like. The concentration of the lithium salt is preferably used in the range of 0.1 to 2.0 M. If the concentration of the lithium salt is included in the range, the electrolyte has appropriate conductivity and viscosity and thus can exhibit excellent electrolyte performance, and the lithium ions can be effectively migrated.

For the purpose of improving service life characteristics of the battery, preventing the reduction in battery capacity, and increasing the discharge capacity of the battery, the electrolyte may further contain at least one additive, for example, a haloalkylene carbonate-based compound such as difluoroethylene carbonate, pyridine, triethylphosphite, triethanolamine, a cyclic ether, ethylenediamine, n-glyme, hexaphosphoric triamide, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride, in addition to the above-described electrolyte components. Particularly, the additive may be contained in a content of 0.1 to 5 wt% relative to the total weight of the electrolyte.

Hereinafter, preferable exemplary embodiments of the present disclosure will be described in detail.

### A. Preparation of Active Material

### Experimental Example 1

A mixture solution was prepared by weighing tetramethyl orthosilicate as a silane, deionized water as a solvent, and 2 M HCl as an acid catalyst at a weight ratio of 44:53:3. The pH of the mixture solution was maintained at 3-4. Hard carbon (with a primary particle size of 500 nm and a secondary particle size of 5 to 15 μm) as a carbon-based material was added thereto at a weight ratio of 1:1, and reacted at room temperature for 12 hours with mixing in a planetary mixer, followed by filtration and subsequently drying at room temperature, thereby preparing an active material composition.

FIG. 1 shows TEM images of the active material composition prepared in Experimental Example 1. Referring to FIG. 1, Si particles were uniformly coated on the surface of carbon particles.

### Experimental Example 2

A mixture solution was prepared by weighing (3-aminopropyl)triethoxysilane as a silane and anhydrous alcohol as a solvent at a weight ratio of 1:20. Hard carbon as a carbon-based material was added thereto at a weight ratio of 1:1, and reacted at a temperature of 60° C. for 12 hours with stirring under heating. The reacted composition was filtered and then dried at room temperature, thereby preparing an active material composition.

### Experimental Example 3

An aqueous PTFE emulsion was prepared at 2 wt%. The emulsion was mixed with 3 g of a carbon-based material powder. Then, the mixture of the aqueous PTFE emulsion and the carbon-based material powder was added to 30 mL of deionized water, followed by uniform dispersion at room temperature through magnetic stirring for 2 hours. The dispersed mixture was heated at 110° C. to remove the solvent, and dried at 110° C. for 12 hours in ambient air in an oven, thereby preparing an active material composition.

FIG. 7 shows TEM images of the active material composition prepared in Experimental Example 3. Referring to FIG. 7, PTFE was uniformly coated on the surface of carbon particles.

### B. Manufacture of anode structure

### Example 1

The active material composition prepared in Experimental Example 1, a binder, and a conductive material were mixed at a ratio of 80:15:5 in a mixer. Particularly, water was used as a solvent, and polyacrylic acid (PAA) as a binder and Super P as a conductive material were used. The prepared slurry was casted on a copper foil, and then the solvent was removed by drying at 80° C. for 30 minutes in an oven. The thickness of a first active material layer laminated after the completion of drying was about 35 μm.

The active material composition prepared in Experimental Example 2, a binder, and a conductive material were mixed at a ratio of 80:15:5 in a mixer. Particularly, water was used as a solvent, and polyacrylic acid (PAA) as a binder and Super P as a conductive material were used. The prepared slurry was casted on the first active material layer, and then the solvent was removed by drying at 80° C. for 30 minutes in an oven. The thickness of a second active material layer laminated after the completion of drying was about 45 μm.

### Example 2

For a comparison experimental with a pure PTFE coating film not containing a carbon-based active material, 10 mL of deionized water was added to 2 wt% of aqueous PTFE emulsion, followed by ultrasonic treatment at room temperature for 30 minutes, thereby obtaining a uniform dispersion. This dispersion was slurry casted on an anode current collector using a bar coater. Thereafter, the resultant structure was dried stepwise in ambient air at 40° C., 60° C., 80° C., and 100° C. for 10 min each to stabilize the coating shape and remove the solvent. The dried anode current collector was vacuum dried at 100° C. for 12 hours to remove the residual solvent. The thickness of a first active material layer laminated after the completion of drying was about 35 μm.

The active material composition prepared in Experimental Example 2, a binder, and a conductive material were mixed at a ratio of 80:15:5 in a mixer. Particularly, water was used as a solvent, and polyacrylic acid (PAA) as a binder and Super P as a conductive material were used. The prepared slurry was casted on the first active material layer, and then the solvent was removed by drying at 80° C. for 30 minutes in an oven. The thickness of a second active material layer laminated after the completion of drying was about 45 μm.

### Comparative Example 1

An active material layer of hard carbon without a siloxane coating film was formed with a thickness of 45μm on a current collector, and an active material layer having a positive charge as a second active material layer was formed with a thickness of 45μm similar to that in Example 2.

### Comparative Example 2

An active material layer of hard carbon without a siloxane coating film was formed on a current collector. The thickness of the active material layer was 90 μm.

FIG. 2 shows a graph illustrating the zeta potential measurement results on the top and bottom portions of the anode structure used in Example 1.

As the measurement equipment, Nano ZS (Malvern) from ZetaSizer was used. A specimen used in the analysis was prepared by dispersing 1 wt% of particles of the powder obtained in the example in a solution 1.15 M lithium hexafluorophosphate (LiPF₆) in EC/EMC/DMC (3:5:2) +5 wt% FEC solvent, which has the 6 same composition as an electrolyte used to operate actual cells.

It can be seen from FIG. 2 that positively charged particles and negatively charged particles were distributed on the top and bottom portions of the manufactured electrode, respectively. For comparison, the zeta potential (0.15 mV) on the top portion of the anode structure manufactured in Comparative Example 1 was also measured and recorded.

As shown in FIG. 2, in the anode structure of Example 1, the top portion was positively charged and the bottom portion was negatively charged. Comparative Example 1 showed a very low measured voltage and was neutrally charged.

### C. Performance Evaluation

2032 Coin cells were fabricated using the three-dimensional structures of Example 1 and Example 2 as anodes. Particularly, 1 M LiTFSI in DME/DOL 1:1 (v/v) with 1 wt% of LiNO3 was used as an electrolyte, and LFP (L/L=14.4 mg/cm2) was used as a cathode.

For comparison with Examples 1 and 2, 2032 coin cells were fabricated using the active materials of Comparative Examples 1 and 2 as anodes while the other conditions were identical, and a coil cell using a lithium metal (thickness of 10 μm) as a cathode was further fabricated.

The electrochemical properties of the fabricated coin cells were evaluated. The test conditions were as follows.
Charging: 1C CC only
Discharging: 1C, CC only
Voltage range: 2.5 V to 3.8 V
Cathode: LFP (Loading level: 14.4mg/cm2 )

FIG. 3 shows a graph illustrating the cycle test results of the coil cells of the examples and comparative examples. When the fabricated coin cells were subjected to long-term charge and discharge, Comparative Examples 2 and 3 exhibited rapid degradation behavior before 200 cycles. Example 1 and Comparative Example 1 exhibited stable operation during 400 cycles. Example 1 exhibited higher capacity retention properties than Comparative Example 1 throughout all the cycles.

FIG. 4 shows a graph illustrating the rate capability measurement results of the fabricated coin cells. The rate capability characteristics were measured by performing two cycles of charge and discharge at 0.1, 0.5, 1.0, 2.0, 4.0, and 6.0 mA/cm², followed by a final cycle of charge and discharge at 0.1 mA/cm². As shown in FIG. 4, Example 1 exhibited superior rate capability characteristics compared with the comparative examples.

FIG. 5 shows electron microscope images illustrating the deposition state of lithium on the active material layer after 100 cycles of the coin cell fabricated in Example 1. Lithium was deposited onto the anode structure at 5 mAh/cm².

In FIG. 5, the left image shows the state before Li deposition (“Bare”), and the right image shows the state after Li deposition. The images indicate that the pores in the bare state were uniformly filled in both the top and bottom portions of the anode structure after lithium deposition. The diagram on the left of FIG. 5 schematically illustrates that lithium ions penetrate the active material layer.

FIG. 6 shows electron microscope images illustrating the state of the coating layer of the active material after 100 cycles of the coin cell of Comparative Example 1, indicating that pores were compactly filled in the top portion, but the lithium metal was filled in a dendrite form in the bottom portion.

FIG. 8 illustrates Coulombic efficiency test results of examples and a comparative example. Referring to FIG. 8, Example 2 exhibited excellent coulombic efficiency compared with Comparative Example 1.

Meanwhile, the examples described in the present specification and drawings are merely the representation of specific examples to aid the understanding, and are not intended to limit the scope of the present disclosure. It would be obvious to a person skilled in the art to which the present disclosure pertains that other modifications based on the technical spirit of the present disclosure in addition to the examples disclosed herein can be implemented.

What is claimed is:

1. An anode structure for a lithium secondary battery, comprising:
a first active material layer of a carbon-based material powder including a first coating film having a negative charge on the surface in an electrolyte; and
a second active material layer of a carbon-based material powder laminated on the first active material layer and including a second coating film having a positive charge on the surface in an electrolyte.

2. The anode structure of claim 1, wherein the first and second coating films are siloxane coating films.

3. The anode structure of claim 1, wherein each of the carbon-based materials includes at least one selected from the group consisting of artificial graphite, natural graphite, graphitized carbon fibers, graphitized mesocarbon microbeads, petroleum coke, carbonized resin, carbon fibers, and pyrolytic carbon.

4. The anode structure of claim 1, wherein the first active material layer has a thickness of 30 to 50 μm.

5. The anode structure of claim 1, wherein the second active material layer has a thickness of 30 to 50 μm.

6. The anode structure of claim 1, wherein the first coating film contains, as a functional group, at least one selected from the group consisting of —PO₃H₂, —COOH, —SO₄H, —SO₃H, —OH, and —BO₃.

7. The anode structure of claim 1, wherein the first coating film contains, as a function group, at least one selected from the group consisting of —NH2, —NH—, imidazolium, and —N+(CH)³)₃.

8. The anode structure of claim 1, wherein the first coating film is a PTFE coating film.

9. The anode structure of claim 8, wherein the second coating film is a siloxane coating film.

10. A lithium secondary battery, comprising:
an anode comprising the anode structure according to claim 1;
a cathode containing an active material represented by the chemical formula LiₓNi_{1-y}M′_{y}O_{2-α}A_{α} (where, 0.95≤x≤1.1, 0≤y≤0.5, 0≤z≤0.5, 0≤α≤2, M′ is at least one element selected from the group consisting of Al, Ni, Co, Mn, Cr, Fe, Mg, Sr, V, and a rare earth element, and A is an element selected from the group consisting of F, S, and P);
a separator for separating the anode and the cathode; and
an electrolyte containing an organic-based polar solvent.

11. The lithium secondary battery of claim 10, wherein the first and second coating films are siloxane coating films.

12. The lithium secondary battery of claim 10, wherein each of the carbon-based materials includes at least one selected from the group consisting of artificial graphite, natural graphite, graphitized carbon fibers, graphitized mesocarbon microbeads, petroleum coke, carbonized resin, carbon fibers, and pyrolytic carbon.

13. The lithium secondary battery of claim 10, wherein the first active material layer or the second active material layer has a thickness of 30 to 50 μm.

14. The lithium secondary battery of claim 10, wherein the first coating film contains, as a functional group, at least one selected from the group consisting of —PO₃H₂, —COOH, —SO₄H, —SO₃H, —OH, and —BO₃.

15. The lithium secondary battery of claim 10, wherein the first coating film contains, as a function group, at least one selected from the group consisting of —NH2, —NH—, imidazolium, and —N+(CH)³)₃.

16. The lithium secondary battery of claim 10, wherein the first coating film is a PTFE coating film.

17. A method for preparing an anode active material for a lithium secondary battery, the method comprising:
preparing a carbon-based material; and
forming a siloxane coating film having a positive surface charge on the surface of the carbon-based material.

18. The method of claim 17, wherein the forming of the siloxane coating film comprises:
dissolving a silane in anhydrous ethanol to prepare a silane solution;
mixing a carbon-based material powder with the silane solution, followed by heating and stirring; and
filtering and drying the reaction product.

19. The method of claim 18, wherein the silane includes (3-aminopropyl)triethoxysilane.

20. The method of claim 18, wherein the heating step is performed at 50 to 70°C.
